(19) United States
(12) Patent Application Publication
(10) Pub. No.: US 2009/0281850 A1
(43) Pub. Date: Nov. 12, 2009

(54) Situational Awareness System And Method And Associated User Terminal

(75) Inventors: Alan E. Bruce, Kent, WA (US); Daniel J. Gadler, Mercer Island, WA (US); Kyle M. Nakamoto, Bellevue, WA (US)

Correspondence Address: ALSTON & BIRD, LLP, BANK OF AMERICA PLAZA, 101 SOUTH TRYON STREET, SUITE 4000, CHARLOTTE, NC, 28280-4000, US

(73) Assignee: The Boeing Company, Chicago, IL (US)

(21) Appl. No.: 12/202,858

(22) Filed: Sep. 2, 2008

Related U.S. Application Data
(60) Provisional application No. 61/050,846, filed on May 6, 2008.

(51) Int. Cl. G06Q 10/00; H04M 11/04; H04W 4/12; G06F 15/16; G01C 21/26

(52) U.S. Cl. 705/7; 455/404.1; 455/466; 709/203; 701/200; 715/751

(57) ABSTRACT

A system, method and user terminal are provided to facilitate common situational awareness including, for example, awareness of evacuation and emergency vehicle routes. The system includes a plurality of user terminals in communication with a computing device, such as one or more servers. Each user terminal may include a processor and an associated display. The user terminals are configured to receive the evacuation routes and/or the routes for the emergency vehicles, as well as optionally other information regarding the underlying situation, from the computing device for display thereat. The user terminals may provide a field incident report to a computing device that provides the user terminals with information regarding the emergency situation.

### CROSS-REFERENCE TO RELATED APPLICATIONS

The present application claims priority to U.S. Provisional Application No. 61/050,846 filed May 6, 2008, the contents of which are incorporated herein in its entirety. This application is also related to the following co-pending and commonly-assigned patent applications, which applications are incorporated by reference herein: U.S. patent application Ser. No. 11/113,659, filed Apr. 25, 2005, by Pauline Joe, Kenneth A. Cobleigh, and William F. Lyons, entitled “DYNAMIC ROUTING TOOL”; U.S. patent application Ser. No. 11/113,941, filed Apr. 25, 2005, by Daniel J. Gadler, entitled “AGTM AIRBORNE SURVEILLANCE”; U.S. patent application Ser. No. 11/113,640, filed Apr. 25, 2005, by Steven F. Cuspard, Daniel J. Gadler, Kenneth A Cobleigh, and Pauline Joe, entitled “ADVANCED GROUND TRANSPORTATION MANAGEMENT”; U.S. patent application Ser. No. 11/113,660, filed Apr. 25, 2005, by Kenneth A. Cobleigh, Pauline Joe, Daniel J. Gadler, and Steven F. Cuspard, entitled “GEO-INFOSPHERE AS APPLIED TO DYNAMIC ROUTING SYSTEM”; U.S. patent application Ser. No. 11/113,691, filed Apr. 25, 2005, by Kenneth A. Cobleigh, Pauline Joe, Daniel J. Gadler, and James R. Hamilton, entitled “DATA FUSION FOR ADVANCED GROUND TRANSPORTATION SYSTEM”; and U.S. Pat. No. 7,349,768, by Alan E. Bruce, Kenneth A. Cobleigh and Pauline Job, entitled “EVACUATION ROUTE PLANNING TOOL”.

### BACKGROUND OF THE INVENTION

1. Field of the Invention

Embodiments of the present invention relate generally to a method, system and user terminal for providing common situational awareness and evacuation and emergency vehicle route planning for the users, such as via respective user terminals.

2. Background of the Invention

Faced with a potentially hazardous emergency threat, such as a fire, tornado, hurricane, tsunami, terrorist attack, deployment of weapons of mass destruction, e.g., chemical, biological, radiological, or nuclear weapons, etc., the objective of most emergency management operations is to provide a rapid and effective response. However, at least some emergency management operations are hampered by the lack of timely situational awareness. For example, there have been reports that the emergency management operations associated with hurricane Katrina, the Northridge quake, recent large urban wildfires and the 9/11 terrorist attack may have been at least somewhat lacking in timely situational awareness.

At least some current emergency management operations depend upon non-integrated disparate systems that do not allow for overall situational awareness to be commonly shared amongst the emergency responder teams, their administrators and the command and control centers, thereby limiting the effectiveness of the emergency responders and others involved in the emergency management operations. For example, emergency operations centers generally do not have real time integrated situational information displays and ubiquitous connectivity to on-scene first responders, which would be advantageous in order to learn more about a particular threat in order to most effectively respond to the threat. Moreover, particularly, although not exclusively, in large metropolitan areas, evacuation routing is a dynamic problem associated with the type, magnitude and direction of the threat as well as the environmental conditions that can affect the threat. In this regard, the environmental conditions can be complex and vary temporally so as to demand constant re-evaluation of the situation and the desired response to the threat. The issues associated with current emergency management operations may be relevant for many entities and municipalities including, but not limited to, towns, townships, cities, counties, states, military and industrial complexes and even entire regions.

From the foregoing, it can be seen, then, that there is a need in the art for interconnectivity between geographical databases, such as Geographical Information System (GIS) databases, and other sources of data. It can also be seen, then, that there is a need in the art to provide access to the geographical databases for management and operations beyond the municipal schema for use by emergency personnel to determine evacuation routes, such as in a dynamic manner based on the imminent or ongoing emergency. Additionally, it would be desirable to provide for improved situational awareness, such as by providing for a common situational awareness to be shared by a plurality of users, such as emergency responder teams, their administrators and the command and control centers.

### SUMMARY OF THE INVENTION

A system, method and user terminal are therefore provided to improve situational awareness by providing a real time common operating picture, including evacuation routes and emergency vehicle routes, to be available to a plurality of users. In this regard, the system and method of embodiments of the present invention may provide near real time situational awareness through real time incident reporting employing the user terminals, determine evacuation routes and/or routes for emergency vehicles based upon geographic databases as well as, in some embodiments, additional data, such as more real time data. The evacuation routes and/or the routes for the emergency vehicles, as well as optionally other information regarding the underlying situation, may then be provided to the users in order to provide for common situational awareness.

In one embodiment, a system is provided that includes a plurality of user terminals in communication with a computing device, such as one or more servers, via one or more networks, such as a wide area network, such as the Internet, a cellular network, a satellite network and the like. Each user terminal may include a processor and an associated display. As such, the user terminals are configured to receive the evacuation routes and/or the routes for the emergency vehicles, as well as optionally other information regarding the underlying situation, from the computing device for display thereat, thereby providing for common situational awareness.

In one embodiment, the plurality of user terminals may provide a field incident report to a computing device that provides information regarding the emergency situation. Additional information including, for example, one or more updated routes and/or a representation on the field incident report, such as a photograph, a video recording, an audio recording, or a text message, may then be distributed to the plurality of user terminals based upon the field incident report. In this regard, the plurality of user terminals may be further configured to display both the route(s) and the representation of the field incident report.

In another embodiment, the computing device may provide information to the plurality of user terminals identifying a plurality of emergency responders who have been dispatched in response to an emergency situation. In this embodiment, the plurality of user terminals are configured to display the information identifying the plurality of emergency responders and, in response to selection of a respective emergency responder, to initiate communication with the respective emergency responder. In this embodiment, the information identifying the plurality of emergency responders as provided by the computing device and displayed by the plurality of user terminals may include a presence status of the respective emergency responders. In one embodiment, the plurality of user terminals are configured to receive the selection of a plurality of emergency responders and to then initiate concurrent communications with the plurality of emergency responders.

In another aspect, a method is provided that receives information associated with an emergency situation, determines one or more routes based upon the information associated with the emergency situation, provides the one or more routes to a plurality of user terminals for display thereat such that the plurality of user terminals enjoy common situation awareness, receives one or more incident reports from a terminal that provide information regarding the emergency situation, and provides information to the plurality of user terminals based upon the field incident report. In one embodiment, the method also determines one or more updated routes based upon the field incident report such that the provision of the information includes the one or more updated routes to the plurality of user terminals. Additionally, or alternatively, the provision of the information may also include the provision of a representation of the field incident report for display by the plurality of user terminals along with the one or more routes. In this regard, the representation of the field incident report may also include information selected from the group consisting of photographs, video recordings, audio recordings and text messages.

The method may also provide information to the plurality of user terminals identifying a plurality of emergency responders who have been dispatched in response to the emergency situation. The method of this embodiment may also display the information identifying the plurality of emergency responders at the plurality of user terminals, receive a selection of a respective emergency responder at a respective user terminal and initiate communications between the respective user terminal and the respective emergency responder.

In one embodiment, a user terminal may be configured to provide information regarding an emergency situation to the computing device. For example, the user terminal may include a camera by which an image of an emergency situation, e.g., a fire, can be captured. Additionally or alternatively, the user terminal may include a user interface, such as a keypad, a touchscreen, a microphone or the like, for receiving user input regarding the emergency situation. Still further, the user terminal may include a location determination system, such as a GPS receiver, for determining the position of the user terminal such that the processor of the user terminal can annotate the information regarding the emergency situation with the position of the user terminal prior to transmitting the additional information to the computing device. The plurality of user terminals can therefore enjoy common situational awareness that may be updated in real time or near real time by the computing device based upon the information provided by a user terminal.

In this regard, a user terminal of one embodiment may include a display, a processor configured to receive one or more routes based upon an emergency situation and to direct the display to present an image of the one or more routes, an input device configured to receive a field incident report that provides additional information regarding the emergency situation and a transmitter configured to transmit the field incident report to a remote computing device. The processor is also configured to receive additional information from a remote computing device based upon the field incident report. Regarding the additional information, the processor may be configured to receive one or more updated routes based upon the field incident report and to direct the display to present an image of the one or more updated routes. Additionally or alternatively, the processor may be configured to receive a representation in a field incident report and to drive the display to present an image about the one or more routes and the representation of the field incident report. In this regard, the representation of the field incident report may be a photograph, a video recording, an audio recording, or a text message. The processor of the user terminal may also be configured to receive information identifying a plurality of emergency responders who have been dispatched in response to the emergency situation and to drive the display to present an image including the information identifying the plurality of emergency responders. The processor of this embodiment may also be further configured to receive a selection of a respective emergency responder and to initiate communication via the transmitter with the respective emergency responder.

### BRIEF DESCRIPTION OF THE DRAWINGS

Referring now to the drawings in which like reference numbers represent corresponding parts throughout:

FIG. 1A is a representation of a system in accordance with one embodiment of the present invention;

FIG. 1B is a block diagram of a computing device in accordance with one embodiment of the present invention;

FIG. 1C is an exemplary hardware and software environment used to implement one or more embodiments of the evacuation and emergency vehicle routing (EEVR) aspect of the invention;

FIG. 1D is a block diagram of a user terminal in accordance with one embodiment of the present invention;

FIG. 1E provides an overview of the evacuation and emergency vehicle routing system of one embodiment of the present invention;

FIG. 2 illustrates a nodal approach of an embodiment of the present invention;

FIGS. 3A-3E illustrate exemplary graphical user interfaces of the dynamic routing tool provided with one embodiment of the present invention;

FIGS. 4A-4D illustrate exemplary graphical scenarios of the evacuation route planning tool provided with one embodiment of the present invention; and

FIG. 5 illustrates a flow diagram of an exemplary process performed by the evacuation route planning tool of one embodiment of the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is to be understood that other embodiments may be utilized and structural changes may be made without departing from the scope of the present invention.

### Overview

Most state and local agencies use GIS to manage, plan, and record geographical information in their respective jurisdictions. However, these agencies use GIS solely as a mapping tool, rather than using the data in a dynamic manner for routing of vehicles.

Emergency vehicles, commuters, and business fleet management services all can use GIS databases in a dynamic fashion to optimize routes for certain vehicles or for certain situations. For example, and not by way of limitation, if an emergency situation arises, such as the breakout of a large-scale fire, the GIS database can be used to determine the best evacuation routes for the areas where the fire is. Further, the databases can be combined with other information such as wind direction, fire direction and speed of travel, etc. to dynamically determine the best evacuation direction as well as the best routes to take for a given emergency. As roads become placed into service or modified for the evacuation, the system of the present invention can re-route traffic to other roads as these new roads become more time efficient than the original routes.

Depending on the evacuation needed, the system of embodiments of the present invention allows for different parameters to be entered and taken into account, as well as which area needs to be evacuated. For example, and not by way of limitation, if the emergency is a fire, the system of embodiments of the present invention needs information on which way the fire is traveling, and which way the firefighters are going to be fighting the fire, so that evacuation routes can be properly determined to evacuate the area as soon as possible while not interfering with the firefighting effort.

Similarly, for a chemical, biological, radiological, or nuclear attack, the system of embodiments of the present invention needs information on which way the wind is blowing so that a proper evacuation area and safe area may be determined, and for a hurricane evacuation, the system of embodiments of the present invention needs information on the most likely landfall area, whether it is more likely that the hurricane will travel north, south, east, or west of that point given historical weather patterns, and which direction will the hurricane travel once it makes landfall, so that proper safe areas can be established. These additional disaster-specific data points are placed into the system of embodiments of the present invention to assist emergency management operations in evacuating people from certain areas in the most time-efficient manner, as well as making it easier for emergency response personnel to contend with the emergency at hand.

### System

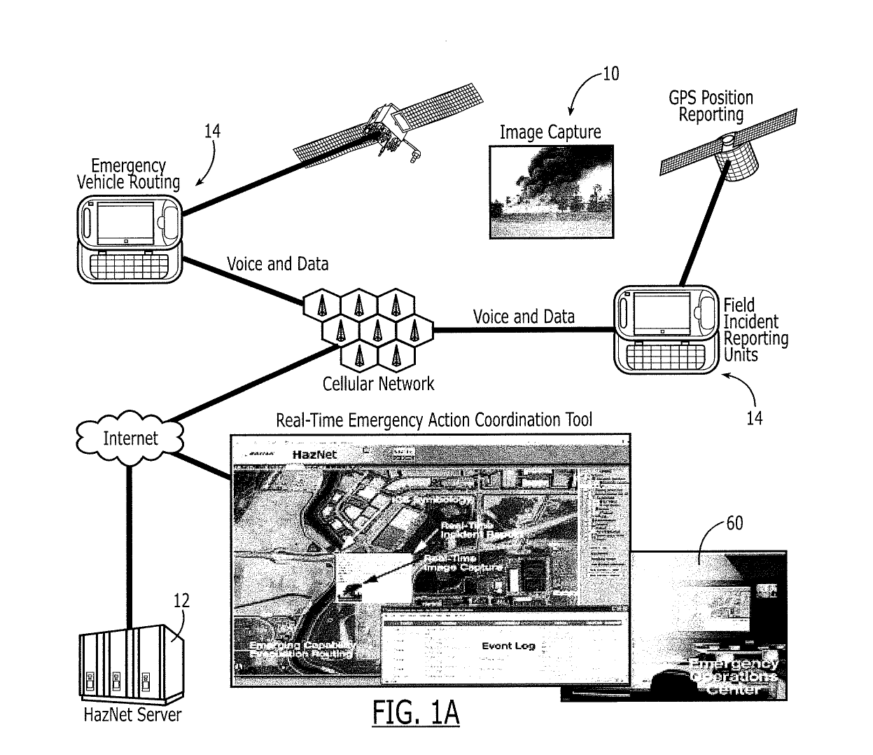

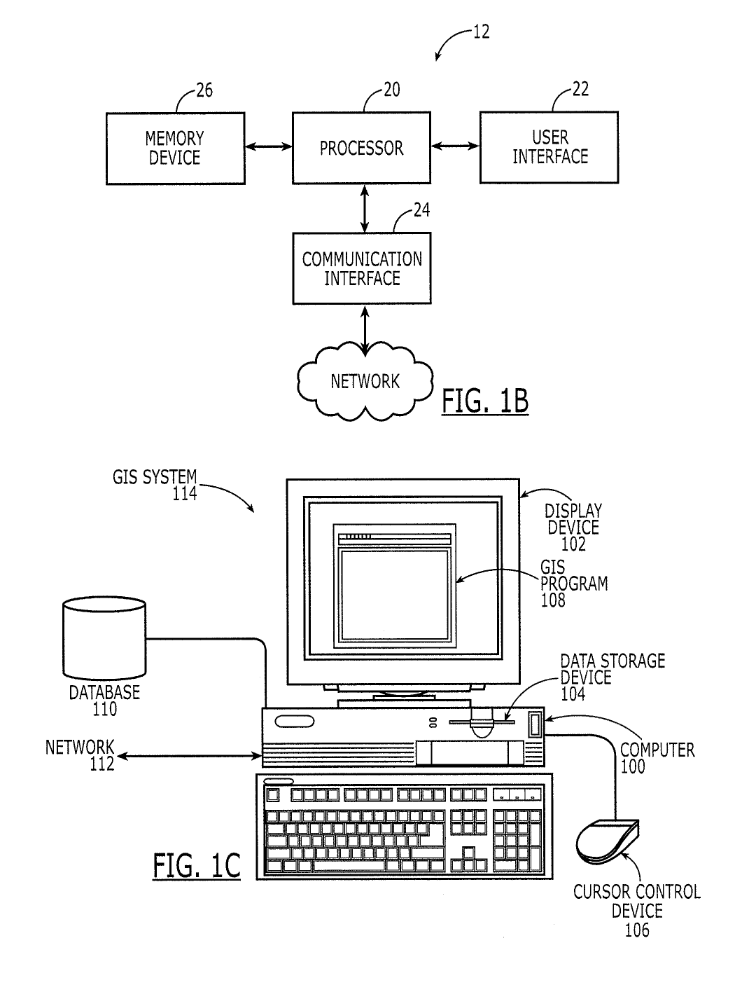

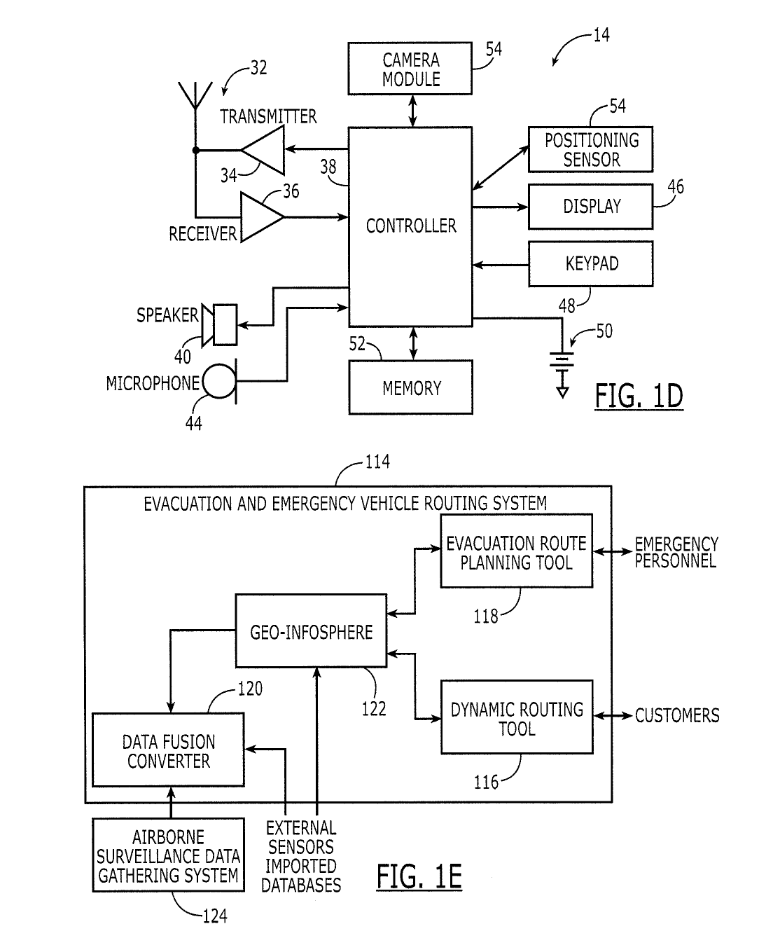

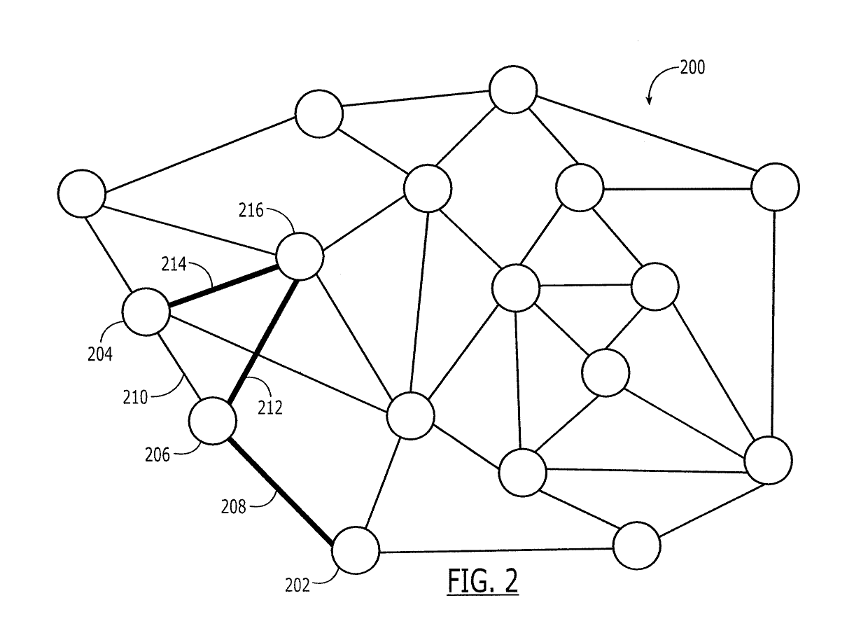

As shown in FIG. 1A, a system 10 of one embodiment of the present invention includes a computing device 12 and a plurality of user terminals 14. In one embodiment, the computing device is comprised of one or more servers including or otherwise in communication with databases, such as GIS databases, for determining the evacuation routes and/or routes for emergency vehicles based upon, for example, emergency-specific information as well as road flow and estimated time of travel for each section of road between an evacuation area and a safe area, as described below. As shown in FIG. 1B, for example, the computing device may include a processor 20, a user interface 22, a communication interface 24 and a memory device 26. The memory device 26 may include, for example, volatile and/or non-volatile memory. The memory device may be configured to store information, data, applications, instructions or the like for enabling the computing device, e.g., server, to carry out various functions in accordance with exemplary embodiments of the present invention. For example, the memory device 26 could be configured to store instructions for execution by the processor 20. The memory device 26 may also include one of a plurality of databases that store information, such as the GIS databases.

The processor 20 may be embodied in a number of different ways. For example, the processor 20 may be embodied as various processing means such as a processing element, a coprocessor, a controller or various other processing devices including integrated circuits such as, for example, an ASIC (application specific integrated circuit). In an exemplary embodiment, the processor 20 may be configured to execute instructions stored in the memory device 26 or otherwise accessible to the processor 20. Meanwhile, the communication interface 24 may be embodied as any device or means embodied in either hardware, software, or a combination of hardware and software that is configured to receive and/or transmit data from/to a network and/or any other device or module in communication with the computing device. As shown in FIG. 1A, the computing device may be configured to communicate with a plurality of user terminals via a wide area network, such as the Internet. However, the computing device may be configured to communicate with the user terminals via one or more other types of networks, such as cellular networks, satellite networks and/or other wireless networks. In this regard, the communication interface 24 may therefore include, for example, an antenna and supporting hardware, e.g., a transceiver, and/or software for enabling communications with a wireless communication network. Indeed, in one embodiment, the computing device is advantageously configured to communicate with the user terminals via two or more networks to provide redundancy and, correspondingly, reliability to the system. In one embodiment, the user interface 22 may be in communication with the processor 20 to receive an indication of a user input at the user interface 22 and/or to provide an audible, visual, mechanical or other output to the user. As such, the user interface 22 may include, for example, a keyboard, a mouse, a joystick, a touch screen display, a conventional display, a microphone, a speaker, or other input/output mechanisms.

By way of further example, FIG. 1C is an exemplary hardware and software environment used to implement one or more embodiments of the computing device. Embodiments of the computing device may be implemented using a computer 100, which generally includes, inter alia, a display device 102, data storage devices 104, cursor control devices 106, and other devices. Those skilled in the art will recognize that any combination of the above components, or any number of different components, peripherals, and other devices, may be used with the computer 100, such as shown more generally in FIG. 1B.

One or more embodiments of the computing device are implemented by a computer-implemented Geographical Information System (GIS) program 108, wherein the GIS program 108 is represented by a window displayed on the display device 102. In one or more embodiments of the invention, the GIS program 108 uses ARCINFO and NETWORK ANALYZER, available from ESRI, Inc. Other Commercial Off-the-Shelf (COTS) software packages can be used if desired without departing from the scope of the present invention.

Generally, the GIS program 108 comprises logic and/or data embodied in or readable from a device, media, carrier, or signal, e.g., one or more fixed and/or removable data storage devices 104 connected directly or indirectly to the computer 100, one or more remote devices coupled to the computer 100 via a data communications device, etc. Further, the GIS program 108 may utilize a database 110 such as a spatial database.

The computing device of one embodiment may be comprised of a plurality of computers with computer 100 connected to other computers 100 (e.g., a client or server computer) via network 112 comprising the Internet, LANs (local area network), WANs (wide area network), or the like. Further, database 110 may be integrated within computer 100 or may be located across network 112 on another computer 100 or accessible device.

Those skilled in the art will recognize that the exemplary system illustrated in FIG. 1C is not intended to limit the present invention. Indeed, those skilled in the art will recognize that other alternative systems may be used without departing from the scope of the present invention. Accordingly, FIG. 1C illustrates an integrated EEVR system 114 that combines the traditional capabilities of GIS tools with other data entries and data properties for use in situational ground traffic routing.

In addition to the computing device 12, the system 10 may also include a wide variety of user terminals 14 including, for example, mobile telephones. It should be understood, however, that a mobile telephone as illustrated and hereinafter described is merely illustrative of one type of user terminal that would benefit from embodiments of the present invention. For example, other types of user terminals, such as portable digital assistants (PDAs), laptop computers, vehicle-mounted GPS units and other types of voice and text communications systems, can readily employ embodiments of the present invention. Still further, the user terminal 14 need not necessarily be mobile, but can be a computer workstation or other types of more fixed terminals, if so desired.

As shown in FIG. 1D, the user terminal 14 of one embodiment may be configured to communicate via a wireless communication network, such as a cellular network and/or a satellite network as shown in FIG. 1A, a wireless local area network or the like, and, as such, may include one or more antennas 32 in operable communication with a transmitter 34 and a receiver 36. The user terminal 14 may further include a processor 38 that provides signals to and receives signals from the transmitter 34 and receiver 36, respectively.

The processor 38 may include circuitry for implementing the functions of the user terminal 14. For example, the processor 38 may be comprised of a digital signal processor device, a microprocessor device, and various analog to digital converters, digital to analog converters, and other support circuits. The processor 38 may be configured to operate one or more software programs, which may be stored in memory. For example, the processor 38 may be capable of operating a connectivity program, such as a conventional Web browser. The connectivity program may allow the user terminal 14 to transmit and receive content, such as the information provided by the computing device 12, via a wide area network, such as the Internet, either in addition to or instead of communication via a wireless communication network. The processor 38 may also be capable of operating a program to facilitate the filing of field incident reports as described below. As noted above in conjunction with the computing device 12, a user terminal 14 of one embodiment is advantageously configured to communicate with the other user terminals and/or with the computing device via two or more networks to provide redundancy and, correspondingly, reliability to the system 10.

The user terminal 14 may also comprise a user interface including an output device such as a conventional earphone or speaker 40, a ringer, a microphone 44 and associated voice recorder, a display 46, and an input interface, all of which are coupled to the processor 38. The input interface, which allows the user terminal 14 to receive data, may include any of a number of devices allowing the user terminal 14 to receive data, such as a keypad 48, a touch display, a joystick or other input device. The user terminal 14 further includes a battery 50 for powering the various elements that are required to operate the user terminal 14. The user terminal 14 may also be equipped with memory 52. Among other things, the memory 52 can store one or more application programs or other software executed by the processor to control the operation of the user terminal.

In an exemplary embodiment, the user terminal 14 also includes an image capturing element, such as a camera, in communication with the processor 38. The image capturing element may be any means for capturing an image, video or the like for storage, display or transmission. For example, in an exemplary embodiment in which the image capturing element is a camera module 54, the camera module 54 may include a digital camera capable of forming a digital image file from a captured image. As such, the camera module 54 includes all hardware, such as a lens or other optical component(s), and software necessary for creating a digital image file from a captured image. Alternatively, the camera module 54 may include only the hardware needed to view an image, while a memory device 52 of the user terminal 14 stores instructions for execution by the processor 38 in the form of software necessary to create a digital image file from a captured image. In an exemplary embodiment, the camera module 54 may further include a processing element such as a co-processor which assists the processor 38 in processing image data and an encoder and/or decoder for compressing and/or decompressing image data.

The user terminal 14 may further include a positioning sensor 56 such as, for example, a global positioning system (GPS) module in communication with the processor 38. The positioning sensor 56 may be any means, device or circuitry for locating the position of the user terminal 14, such as by means of GPS, cell ID, signal triangulation and/or the like. The positioning sensor 56 may include all hardware for locating the position of a user terminal 14. Alternatively or additionally, the positioning sensor 56 may utilize a memory device 52 of the user terminal 14 to store instructions for execution by the processor 38 in the form of software necessary to determine the position of the user terminal 14. Although the positioning sensor 56 of this example may be a GPS module, such as a GPS receiver, the positioning sensor 56 may include or otherwise alternatively be embodied as, for example, an assisted global positioning system (Assisted-GPS) sensor.

In addition to the computing device 12 and the user terminals 14, the system 10 can include an emergency operations center, a network operations center (NOC) or the like (hereinafter generally referenced as emergency operations center 60) from which decisions regarding the deployment of emergency personnel and other information useful in responding to an emergency situation are transmitted. The emergency operations center 60 generally includes one or more computing devices, such as one or more servers, as generically shown in FIG. 1B and described above, configured to communicate with the computing device 12 and the user terminals 14, via one or more networks, such as a wide area network, e.g., the Internet.

### System Overview

FIG. 1E provides a functional diagram of a non-limiting exemplary evacuation and emergency vehicle routing system of embodiments of the present invention which is typically embodied by the computing device 12 and, in particular, the processor of the computing device. The exemplary EEVR system 114 includes a dynamic routing tool 116, evacuation route planning tool 118, data fusion converter 120, and a geo-infosphere 122, all of which may be embodied by the processor and associated memory of the computing device. System 114 accepts input from other information sources, such as but not limited to traffic signals, weather, cameras, road network, external sensors, data from an airborne surveillance data gathering system 124, imported databases, etc. that may be provided in a different format than used by the present invention. These datasets are input to the data fusion converter 120 and stored by the geo-infosphere 122. The EEVR system 114 also provides links to and from customers and emergency personnel. Further details regarding the elements of the exemplary EEVR system 114 including the dynamic routing tool 116, the geo-infosphere 122, the airborne surveillance data gathering system 124 and the data fusion converter 120 as well as the inputs to and the outputs from the data fusion converter are provided by the patent applications incorporated by reference herein including, for example, U.S. Pat. No. 7,349,768 by Alan E. Bruce, et al.

The EEVR system 114 of embodiments of the present invention allows for the collection and management of various data types into a GIS database, such that all of the data can be used to determine optimal traffic flow for a given geographical area at a given time under current and predicted circumstances. The basic GIS data is augmented with various user inputs, or replaced on a temporary or permanent basis with new data supplied by external sources. Such sources may be providing data in different formats to the geo-infosphere 122; as such, the data fusion converter 120 converts the data received into a format that can be stored in the geo-infosphere 122, and updates data within the geo-infosphere 122 as needed. Such real-time or near-real time data can then be utilized by the dynamic routing tool 116 and evacuation route planning tool 118, to optimally compute traffic routes. Data from the airborne surveillance data gathering system 124 can optionally be added to the geo-infosphere 122 via the data fusion converter 120 if such data is available.

In one embodiment of the present invention, such routes may be computed by the EEVR system 114 in response to a request by customers, either via a wireless request using a cellular telephone system or equivalent communications system, e.g., personal communications system (PCS), etc., or a wired system, e.g., telephone system request via internet or other telephone equipment.

In one aspect of the invention, other links that can access the EEVR system 114 may be dedicated to emergency personnel for priority access to the EEVR system 114. Emergency personnel may be determining routes for evacuation, or the best route to respond to an impending or ongoing emergency, and, as such, may need priority handling by the EEVR system 114. These access points, again, can be of a hard-wired or wireless nature.

Within the EEVR system 114, data is converted by data fusion converter 120 as required and stored in the geo-infosphere 122. This data is selectively transferred to and from evacuation route planning tool 118 and dynamic routing tool 116 so that tools 116 and 118 can calculate optimal routes for given situations. Additional data from airborne surveillance data gathering system 124 can optionally be added to the geo-infosphere 122 and converted by the data fusion converter 120 if such data is available.

As routes are calculated or re-calculated by tools 116 and 118, the routing information is passed from the geo-infosphere 122 to customers and emergency personnel. Billing and archival information related to the calculation of the route are maintained. For example, and not by way of limitation, geo-infosphere 122 may keep track of specific customer routes for retrieval for that given customer, or may use those determined routes for other customers within a given time period or if no new data has been stored in the database.

### Dynamic Routing Tool

FIG. 2 illustrates a nodal approach of an embodiment of the present invention. Network structures are typically depicted using nodes and arcs. Arcs are connected sets of line segments, with nodes at the endpoints. In one aspect of the invention, each intersection or place represents a node, and each street is assigned an arc. In another aspect, each arc can represent more than one street or road, and each node can represent more than one intersection, e.g. the nodes can represent neighborhoods or towns, and the arcs can represent all of the roads or streets interconnecting those towns. Nodes and arcs are used to determine distances between points.

A node and arc structure defining a network 200 is illustrated by FIG. 2. In one embodiment of the present invention, the network 200 is created based on the geographic information associated with a given geographic area, and, as such, can be overlaid on a map or graphically displayed to a user of system 114 on display device 102 as a map of the area. The system 114 of embodiments of the present invention, however, is not limited to any geographical area, map, or display technique; users could associate names with the nodes 202 and 204, assign numbers to the nodes 202 and 204, or use any other type of designation that is pertinent to the specific geographic area or planned use for network 200. For example, and not by way of limitation, one user may prefer to use place names for a given node 202, whereas another user may want to use a freeway number or street address associated with node 202. Such assignments or display techniques are not limiting on the present invention, and merely serve to expand the applications of the present invention.

In one embodiment of the present invention, the dynamic routing tool 116 generates an optimum route for either shortest distance or fastest time. Qualities associated with each arc and node within network 200 influence the outcome of the optimization routine. For example, beginning at node 202, if travel to node 204 is desired, a direct route through node 206 using arcs 208 and 210 may be the best route for shortest distance using distance is a factor. However if shortest time is desired, then other attributes are considered. Arcs 212 and 214 which are associated with freeway speeds may be a better route than arc 210 which is limited to local road speeds.

The minimum cost algorithm, also known as “Min Cost,” determines the fastest route between two points, by using an impedance factor assigned to each node. The impedance factor for any given arc can be the length of the road, in which case the shortest route would be calculated. The impedance factor can also be the time it takes to traverse a given stretch of road represented by an arc, which is typically based on the speed limit of that section of road associated with the arc, but can be adjusted to include other factors such as time of day, accidents, or other factors that affect the time it takes to traverse a given stretch of road. In such cases, the fastest, but not necessarily the shortest, route will be calculated. Roads with higher speed limits typically have lower impedances, and, as such, the highest speed limit route typically will have the lowest travel time between two points, but this is not always necessarily so. To determine a minimum cost path within the present invention, Dijkstra algorithms are used to compare costs associated with each arc.

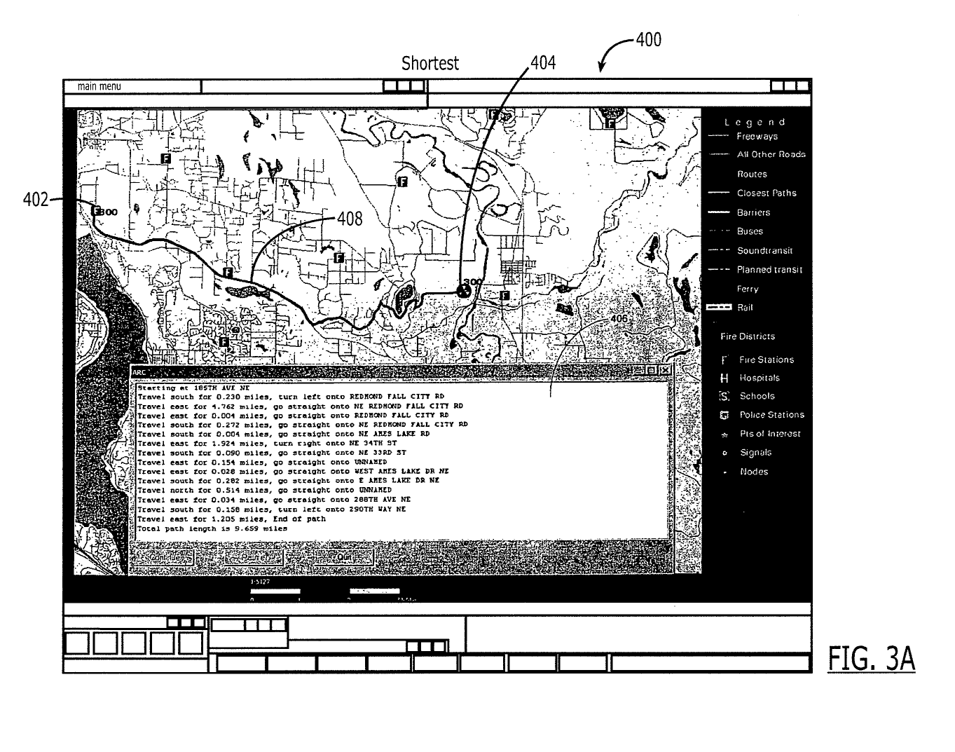

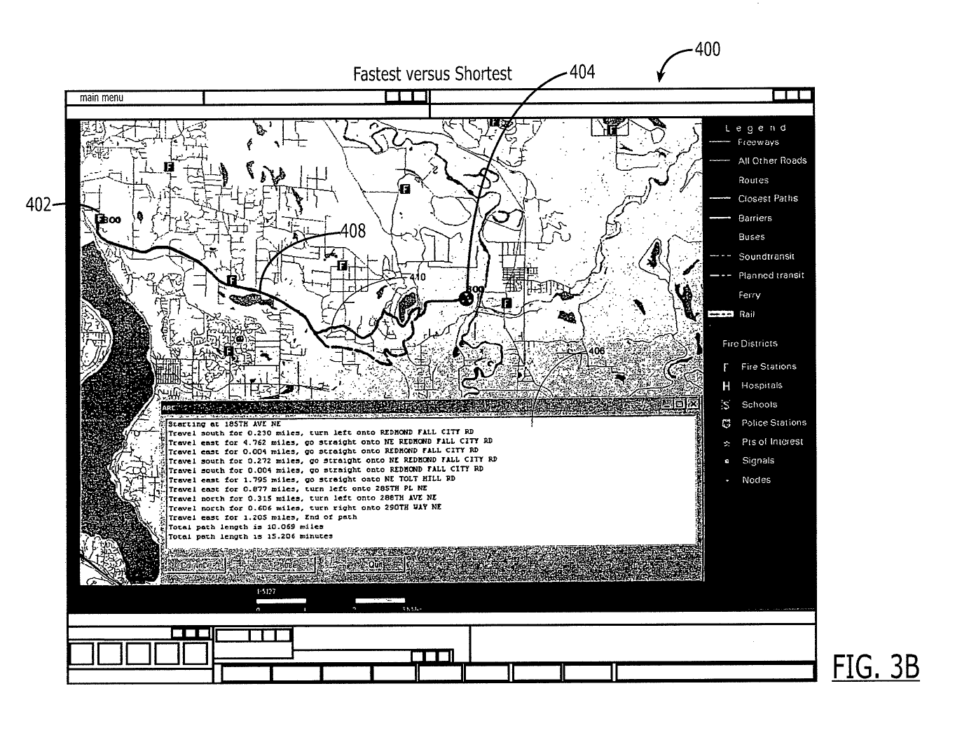

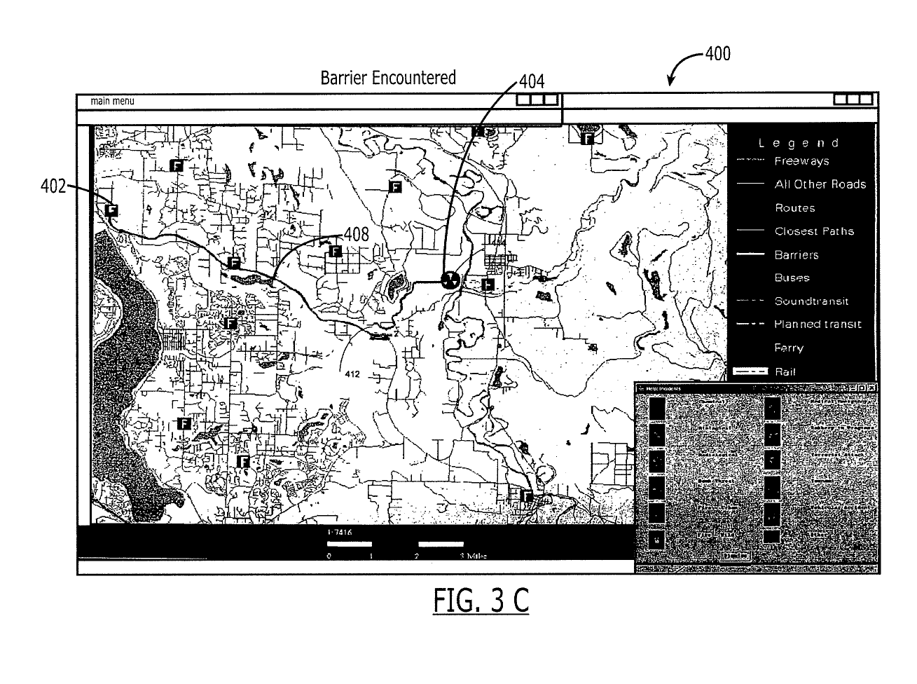

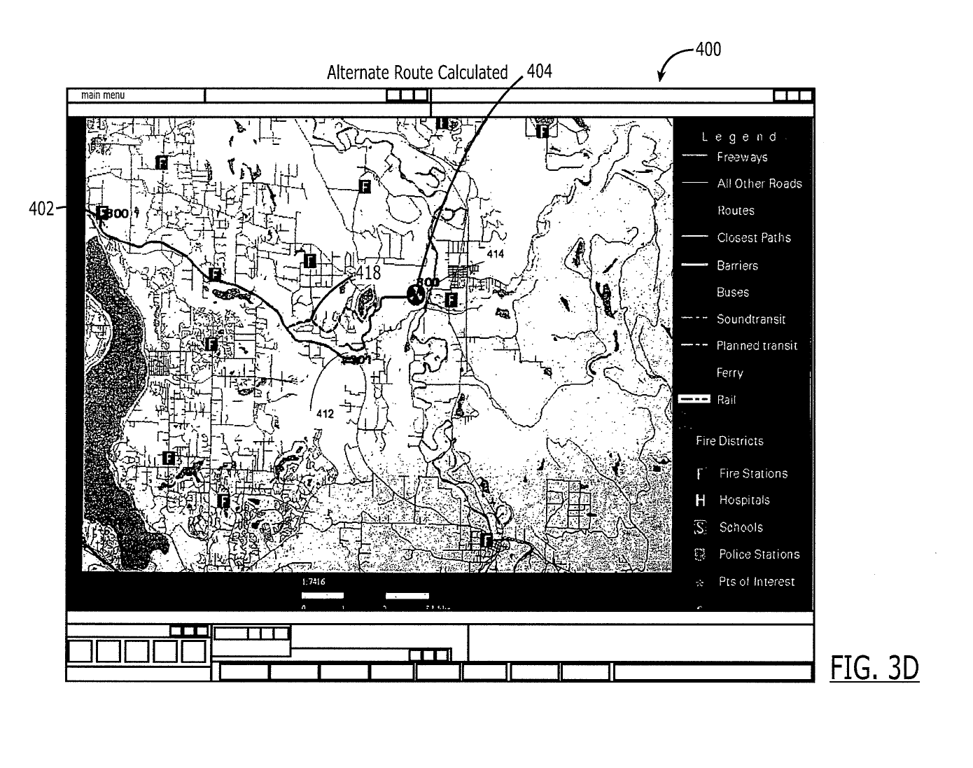

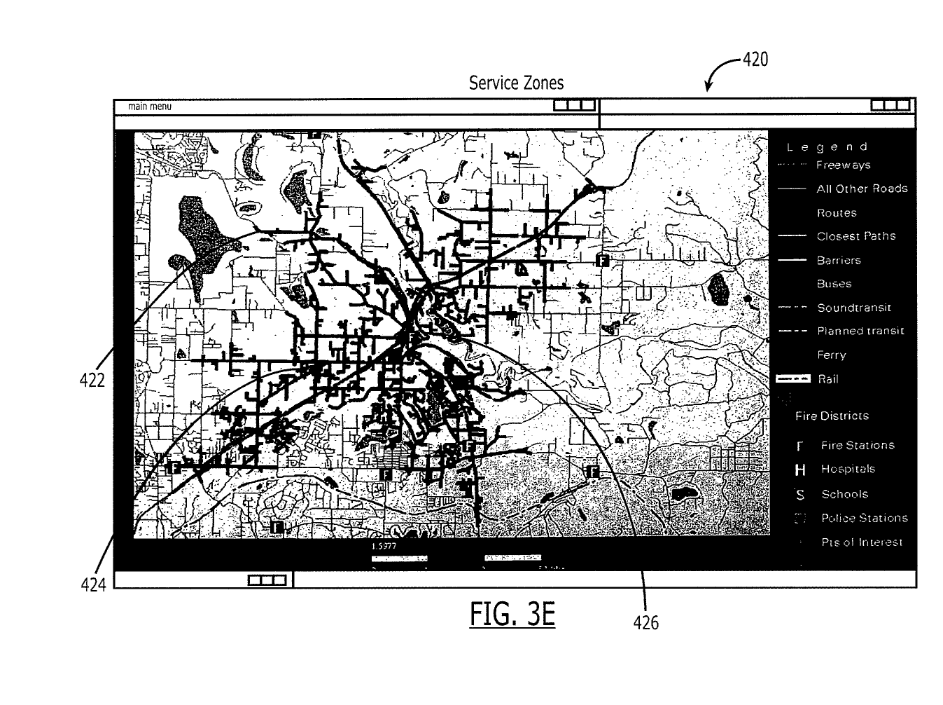

FIGS. 3A-3E illustrate graphical representations of embodiments of the present invention for the dynamic routing tool 116.

FIG. 3A illustrates screen 400 that is displayed on display device 102. Screen 400 shows start point 402 and end point 404, and a second screen 406 showing individual details of route 408. A user can enter start point 402 and end point 404 into the dynamic routing tool 116, with a command to determine the shortest route between start point 402 and end point 408, and the dynamic routing tool 116 will calculate the route 408, with window 406 showing the individual turns and directions which comprise route 408.

FIG. 3B illustrates that the screen 400 can illustrate not only a shortest route 408, but an alternate route 410, which is faster than route 408. Route 410 is determined by using road impedances, which are calculated using road sensors, airborne surveillance 124, and other real-time or near-real-time measurement techniques, so that users can choose the optimal route to travel between start point 402 and end point 404. Directions are again shown in window 406 for the fastest route 410.

FIG. 3C illustrates that when a barrier 412, such as a road blockage, is reported or otherwise discovered to be along route 410, that barrier 412 is reported to the dynamic routing tool 116, which then recalculates route 408. The road impedances that are affected by barrier 412 are reported such that any other calculated routes may also be properly determined.

Incident 414 can be placed into the dynamic routing tool 116 using different icons for different types of barriers such as that shown on the help menu 416. Each type of incident 414 that is being responded to by emergency personnel can have a different icon to represent the type of threat or response that is required. Selection of different icons can trigger different sub programs within the dynamic routing tool 116, e.g., selection of a biological or chemical threat can trigger use of weather data to determine safe areas and evacuation areas, etc. Many different icons can be used to graphically illustrate different types of emergencies or incidents, e.g., chemical attacks, biological attacks, radiological attacks, bomb threats, urban fires, wild fires, medical emergencies, robberies, terrorist attacks, tsunami warnings, vehicle accidents, etc.

FIG. 3D illustrates the new route 418 (indicated by the dash line) determined by the dynamic routing tool 116. The route is calculated based on the current location of the emergency vehicle, the location of the barrier 412 and the location of the incident 414. As described below, embodiments of the present invention use additional inputs to assist in the route determination. For example, and not by way of limitation, emergency vehicles and other automobiles are equipped with Global Positioning System (GPS) receivers that determine the geolocation of that vehicle. Such GPS data can be used to determine speed and direction of that vehicle. When that vehicle is on a road, the true, real-time attainable speed on that road can be determined, rather than using a static posted speed limit to determine the impedance of that road. At times, the speed of the vehicle will be higher than the posted speed limit; at other times, the speed of the vehicle will be lower. This data can be placed into the database and routes can be determined based on the actual speeds attainable on the roadways rather than posted speed limits. Such data will change the impedance of a given road, which will allow the dynamic routing tool 116 of embodiments of the present invention to calculate optimal routes given real-time data. Historical data, airborne collected data, data from GPS or other passive or active sensors can also be used to more accurately model the roadways.

Another embodiment of the present invention is in determining the maximum coverage for a fixed location as illustrated in FIG. 3E. For example, and not by way of limitation, in screen 420 one of the nodes may be a fire station 426. The dynamic routing tool 116 of embodiments of the present invention may be queried by a user to determine all points within the area that are within a given time or distance from the fire station 426. In this example two possible solutions are displayed. The broad lines 422 emanating from the fire station 426 represent an area that can be serviced within 5 minutes; the dotted lines 424 emanating from the fire station 426 represent an area that can be serviced within 3 minutes. This information can be used to determine approximate response times for the fire station 426, and can assist emergency management personnel in responding to a given emergency.

### Evacuation Route Planning Tool

In one embodiment of the present invention, the evacuation route planning tool 118 determines optimum routes between evacuation areas containing multiple nodes and safe areas which also are made up of multiple nodes.

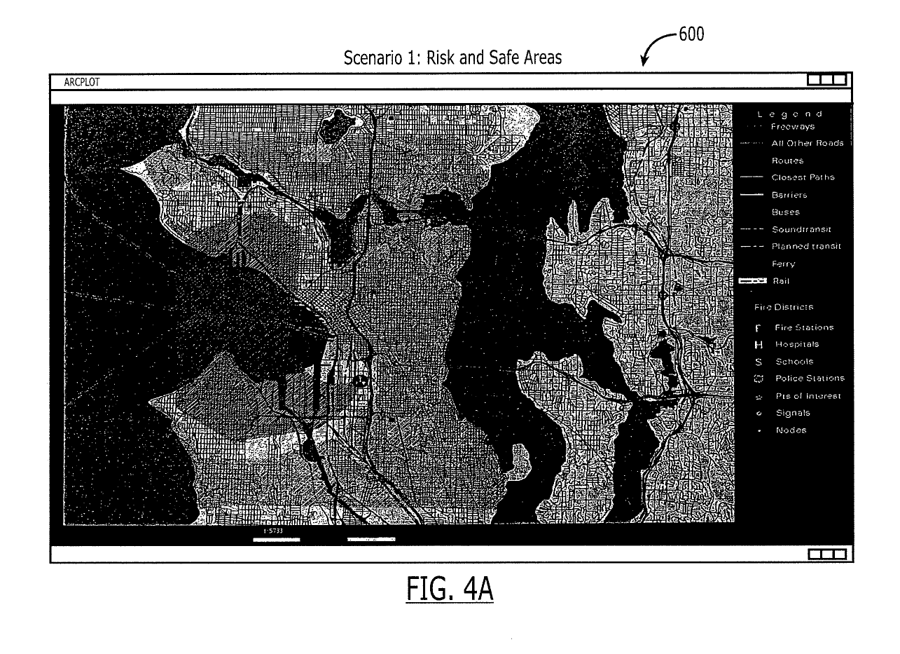

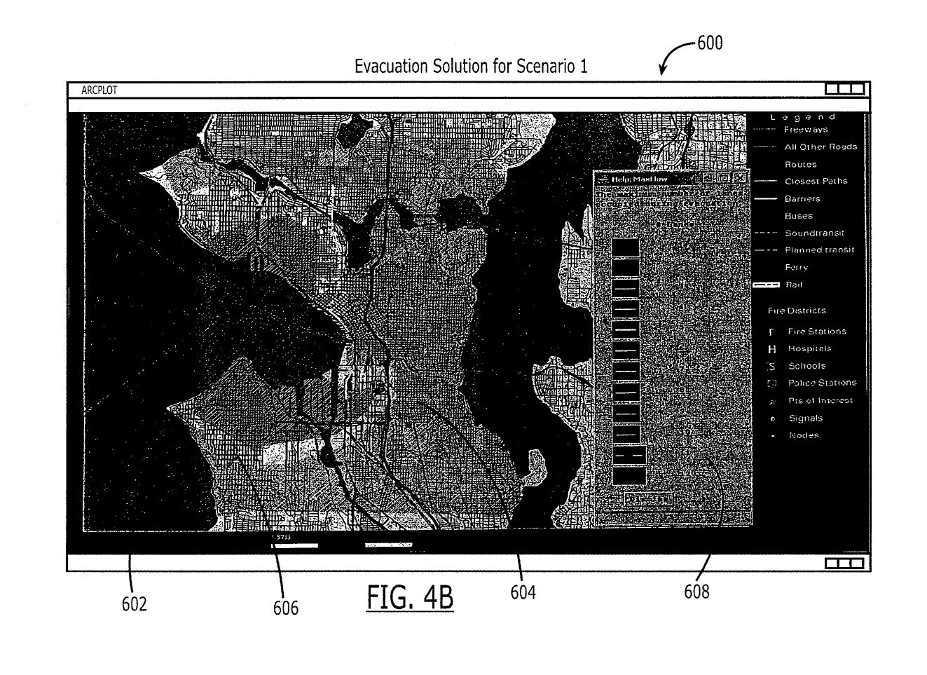

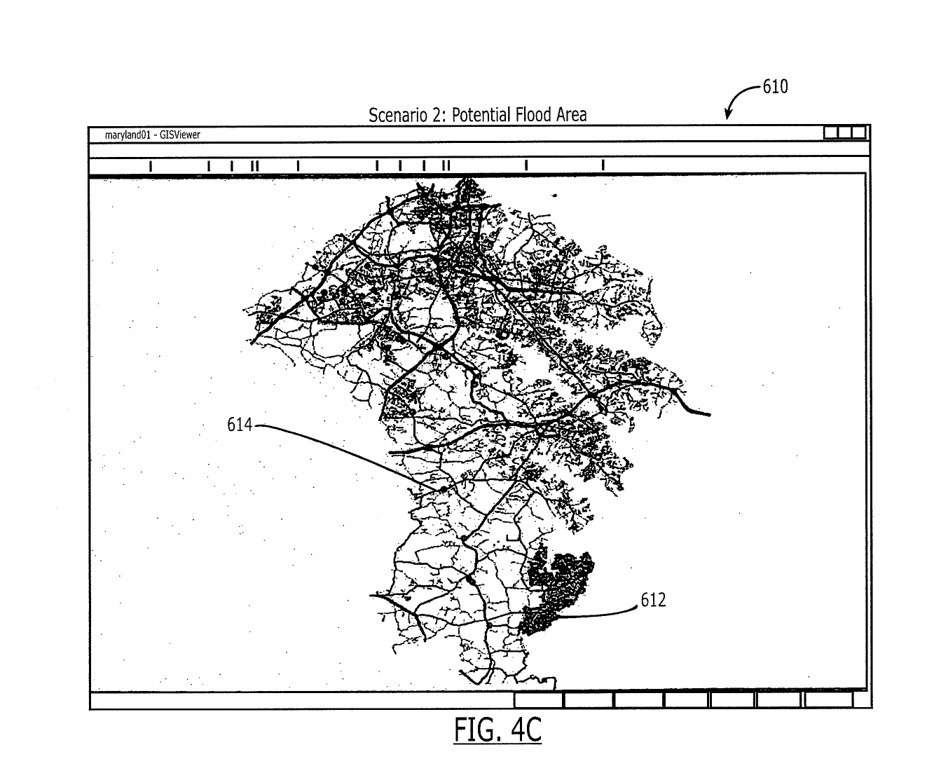

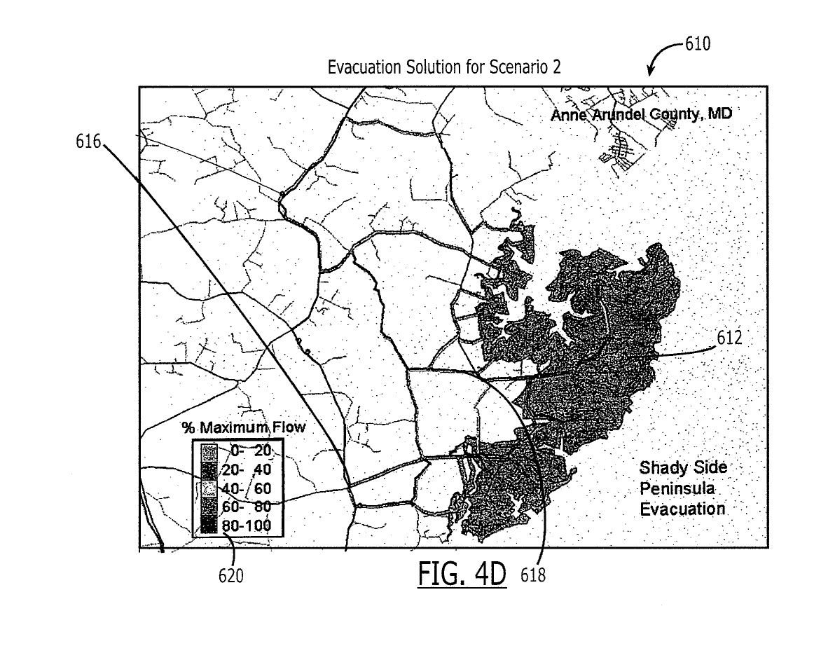

FIGS. 4A-D illustrate graphical representations of embodiments of the present invention for the evacuation route planning tool 118.

For example, FIG. 4A presents a scenario in which a dirty bomb has been activated in area 600. Based on size of the explosive and the wind speed and direction, a risk area 602 and a safe area 604 are identified by the operator. The evacuation route planning tool 118 then determines the optimum routes 606 and the number of lanes available during the routes for evacuating from the risk area to the safe area. This is illustrated in FIG. 4B. A help file 608 provides a color coding for the number of lanes available for a given segment.

In the second scenario, the area 610 defines a potential flood area 612 as shown in FIG. 4C. Potential schools that can be used as safe havens for flood victims are represented by circles 614. The amount of time allowed for evacuation and the number of vehicles residing in the flooded area is selected by the user. The evacuation route planning tool 118 then calculates which safe areas 616 are achievable and the optimum routes 618 from the flooded area 612 as illustrated in FIG. 4D. A color coded legend 620 is provided indicating how fully occupied the road segment is during the evacuation.

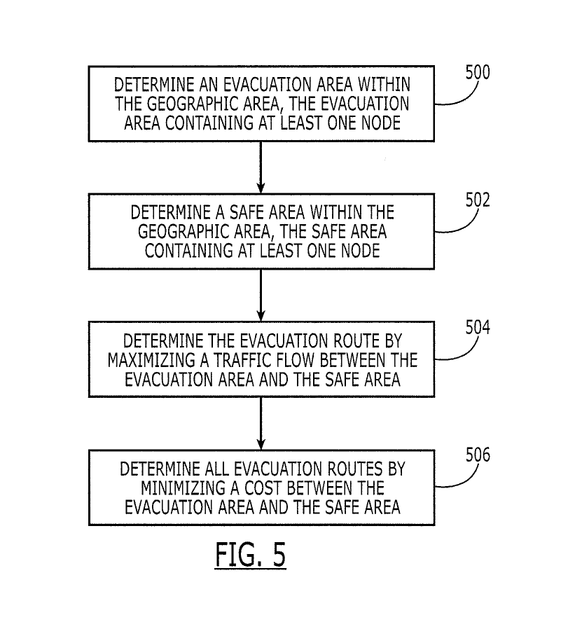

FIG. 5 illustrates a non-limiting, exemplary process performed by the evacuation route planning tool 118. At box 500 an evacuation area within the geographic area is identified. An evacuation area contains at least one node. Examples of events resulting in evacuation include large-scale urban fires, wildfires, weapons of mass destruction (chemical clouds, biological, nuclear), tsunamis, hurricanes, etc. At box 502 a safe area within a geographic area is determined. A safe area consists of an area outside the evacuated area. A safe area contains at least one node.

At box 506 the maximum amount of traffic flow between the evacuation area and the safe area is evaluated. The maximum flow algorithm, also known as “Max Flow,” developed by Ford & Fulkerson is used to determine the maximum amount of traffic flow that can move from one area to another, or evacuate any given area. Flow is typically determined by the number of lanes of traffic, however, as seen above, can be modified based on other events, such as accidents, road closures, or road construction. The number of lanes each road can accommodate is assigned to each arc. In the network 200, for example, arc 208 may be a freeway with three lanes of traffic in each direction, and arc 210 may be a city street with one lane of traffic in each direction. If the EEVR system 114 of embodiments of the present invention is given a command to minimize the distance between node 202 and node 204 and then calculate a route to take, the route would most likely be to take arcs 208 and 210 in accordance with the Min Cost algorithm.

However, if arc 212 is a freeway with three lanes of traffic in each direction, and arc 214 is also a freeway with three lanes of traffic in each direction, and the EEVR system 114 of embodiments of the present invention is given a command to maximize the flow between node 202 and node 204, the most likely result is that the EEVR system 114 would select a route that uses arc 208, arc 212, and arc 214, traveling through an additional node 216. Even though this route may be longer in terms of distance, it would allow the maximum flow between node 202 and node 204. Other data may be given to the evacuation route planning tool 118 of embodiments of the present invention, such as road closures, hour of the day to determine rush hour traffic, current traffic conditions on specific arcs within network 200, fire danger, topology for use in flood evacuations, etc., which may allow the evacuation route planning tool 118 to select a different route to satisfy the conditions given. For example, and not by way of limitation, even though the maximum theoretical flow would be to take the freeway from node 202 to node 204, i.e., use arcs 208, 212, and 214, it may be during rush hour, and the freeway is at a standstill. Thus, staying on the freeway for as small amount of time as possible would increase the flow between node 202 and node 204, and thus, the EEVR system 114 of embodiments of the present invention would take that situation into account when planning a route between nodes 202 and 204.

At box 508 routes from the evacuation area to the safe area are further evaluated such that the time to get to the safe zone is minimized. Road impedance is used as a factor for cost. At least one evacuation route between the evacuation area and the safe area is computed. The evacuation route dynamically computed will contain at least one arc.

In a dynamic situation, the focus on only Max Flow or Min Cost is not enough to ensure that the optimal path is selected. As such, embodiments of the present invention use a combination of Max Flow/Min Cost, and then optimize that solution even further based on the data in the database.

Further, embodiments of the present invention use real-time data acquisition to augment the Max Flow/Min Cost algorithms to include current conditions into the Max Flow/Min Cost calculations. Further, with an emergency situation, embodiments of the present invention can calculate different routes for different evacuees, because if all evacuees are directed to travel along the same roads, the flow on the selected roads may be reduced. As such, as flow on roads are determined during an emergency evacuation situation, evacuees can be redirected to use other roads to maximize the flow from a given area, rather than focusing on the flow from a given node or flow along a given arc within the system 200.

### Common Situational Awareness and Field Incident Reporting

As described above, based upon the information regarding an emergency situation, such as the evacuation areas, the safe areas and the roadways therebetween, a system 10 and, in particular, the computing device 12 may determine the evacuation routes and/or routes to be taken by emergency vehicles. Information regarding the routes may then be distributed via one or more networks, such as the Internet, cellular network(s) and/or satellite network(s), from the computing device 12 to one or more emergency operation centers 60 and one or more user terminals 14 for display thereat. In one embodiment, the user terminals 14 include a processor 38 for receiving the information regarding the routes and for driving the display 46 to provide an image in which the evacuation routes and/or the routes for the emergency vehicle can be displayed to the user. The display of the route may be a graphical representation of the roadway, a photographic representation of the roadways or some other representation. In addition to the routes, the information provided by the computing device 12 and displayed by the user terminals 14 may include the location of emergency response assets and the location and nature of the emergency situation, e.g., by appropriately locating an icon representative of a tornado, bomb or the like, in real time or near real time. By providing the same information to each of the user terminals 14, the users enjoy common situational awareness in order to facilitate an efficient response to the emergency situation.

In addition to the information defining the routes, the information defining an event log associated with the emergency situation may also be compiled and distributed by the computing device 12, either to all user terminals 14 or to just a subset of the user terminals, such as the user terminals associated with emergency personnel, as well as the emergency operation center 60. The event log can include a listing, such as a chronological listing, of events associated with the emergency situation. Various events may be included in the listing, such as an identification of emergency personnel who have been dispatched and information identifying where and when the respective emergency personnel were dispatched. The information which comprises the event log is typically provided by the computing device 12 based upon information collected over time and stored by its memory device 26.

In accordance with one embodiment to the present invention, the user terminals 14 can provide for field incident reporting. In this regard, an operator of a user terminal 14 can input information via an input device that is associated with the emergency situation and can transmit the information, such as via the transmitter 34 and antenna 32, to the computing device 12 via one or more networks, as described above. The user can input a variety of information via a variety of different input devices, such as the image capturing module 54, the microphone 44 and associated voice recorder, the input interface including the keypad 48, or the like. For example, the operator of a user terminal 14 having a camera module 54 can capture an image of the emergency situation, such as a fire, and can forward the image via one or more networks to the computing device 12. Additionally, or alternatively, the user can input information via the input interface, such as by typing a message via keypad 48 describing some aspect of the emergency situation, by utilizing the microphone 44 and voice recorder to record an audible message, or by utilizing the microphone 44 to input an audible message and convert it to text using software specially developed for the user terminal, also known as an incident reporting device (IRD), which is then transmitted to the computing device 12. Along with the information associated with the emergency situation, the user terminal 14 and, in one embodiment, the processor 38 of the user terminal 14 can also provide other related information, such as a time stamp defining the time and date at which the information was captured, such as the time and date at which the image was captured.

As noted above, the user terminal 14 may include a positioning sensor 56, such as a GPS receiver, for receiving signals from which the location of the user terminal 14 at the time at which the user inputs information regarding the field incident report can be determined. Regardless of the manner in which the position of the user terminal 14 is identified, the geolocation of the user terminal 14 can also be provided along with the information associated with the emergency situation such that the computing device 12 can appropriately locate the additional information relative to, for example, the routes which have been previously determined.

Based upon the information associated with the emergency situation provided by the user terminal 14, the computing device 12 may again determine the routes, such as the evacuation routes and/or the routes for the emergency vehicle. In this regard, the information provided by the user terminal 14 associated with an emergency situation may indicate that the emergency situation has changed since a prior incident report such that a road that was previously utilized in the evacuation route is no longer passable. As such, the computing device 12 may again determine appropriate evacuation routes, e.g., updated routes, after having taken into account the updated information regarding the emergency situation including the impassable road.

Additionally, the computing device 12 can provide updated information regarding the emergency situation to each of the user terminals 14 with a representation of the updated information being displayed by user terminals including the updated routes and a representation of the most recent field incident report. In the embodiment depicted in FIG. 1A, for example, a window may be superimposed upon the photo or map which depicts the image captured by the user terminal 14 providing the field incident report along with associated information, such as the geolocation information, time and date information and the like. Depending upon the form of the field incident report, the computing device 12 can provide various types of representations including a photograph, a video recording, an audio or voice recording, a text message or the like. In this regard, a text message includes any type of message including alphanumeric or other characters in any format and transmitted via any protocol and in any manner. As such, the information provided by the computing device 12 to the user terminals 14 and the emergency operation center 60 can be updated in real time or at least near real time. Moreover, by providing the same information to each of the user terminals 14, the users enjoy common situational awareness in order to facilitate an efficient response to the emergency situation.

Although the computing device 12 is described to determine the routes including the updated routes based upon the field incident reports, a user terminal 14 may, instead, include or have access to the geographic databases and may be configured to receive input from various information sources and field incident reports form other user terminals and to determine the evacuation and/or emergency vehicle routes, including the updated route(s) based upon the field incident reports. In this regard, the user terminal may then display the evacuation and/or emergency vehicle routes for the user and, in one embodiment, may distribute the routes to the other user terminals. As such, the functionality described herein with regard to the computing device 12 may, instead, be provided by one or more user terminals 14 and, in particular, the respective processors 38 of one or more user terminals in other embodiments. As such, one or more user terminals may include the dynamic routing tool 116 and the evacuation route planning tool 118, as described above

In addition to providing communications between the computing device 12 and the user terminals 14, the system 10 of one embodiment of the present invention also provides communications between the user terminals 14, such as the user terminals 14 for two or more emergency responders. In this regard, the network(s) which support communication between a user terminal 14 and the computing device 12 can also support communications directly between the user terminals 14. In one embodiment, for example, the information provided by the computing device 12 to the user terminals 14 can identify each of the emergency responders dispatched in response to an emergency situation, such as in the form of an event log. The user terminals 14, in turn, may display the identity of the emergency responders and, in some embodiments, contact information for the emergency responders.

The computing device 12 of one embodiment can also determine and maintain the presence status for each of the emergency responders. In this regard, the presence status indicates if the emergency responder is currently in communication or available for communication via the network(s). For example, an emergency responder who has activated their user terminal which, in turn, has made contact with the network(s) may be considered to be present, while an emergency responder who has not activated their user terminal may be considered not to be present. Thus, the information provided by the computing device 12 to the user terminals 14 may also indicate the presence status of the emergency responders. The user terminals may then also display the presence status, such as by means of an icon associated with those emergency responders who are present.

In this embodiment, the user terminal 14 of one of the emergency responders can receive an indication from its respective user that the user wishes to communicate with another one of the emergency responders, such as via the user touching a touch screen at a location corresponding to a listing in the event log of the emergency responder with which the user wishes to communicate. In response, the user terminal 14 of one emergency responder can then initiate communications via the network with the user terminal of the other emergency responder, such that the emergency responders can coordinate their activities for the like. For example, based upon the selection of a respective emergency responder, the processor 38 of the user terminal 14 can determine contact information for the respective emergency responder, such as an email address, a phone number, etc. In this regard, the contact information for the emergency responders may be provided by the computing device 12, such as along with the event log or prior to provision of the event log. Depending upon the contact information for the respective emergency responder, the processor 38 of the user terminal 14 can then initiate communications, such as by initiating an online chat session, placing a telephone call, or the like. Although the communication between the emergency responders can include the computing device 14 and/or the emergency operations center 60, the communication initiated by the user terminal 14 in response to the user's selection of an emergency responder may be independent of the computing device and the emergency operations center 60.

In addition to receiving a selection of a single emergency responder, the user terminal 14 of one embodiment can receive a selection of a group of emergency responders, such as all emergency responders who are responding to an emergency situation who are from a common stationhouse. The user terminal 14 and, more typically, the processor 38 of this embodiment can then initiate concurrent communications, such as by initiating an online chat or a conference call between the group of emergency responders, via the network with the user terminals of all of the selected emergency responders in order, for example, to coordinate the activities of the group of emergency responders.

### Preventative and Predictive Use

The evacuation routes determined by the EEVR system 114 of embodiments of the present invention can also be used to overcome infirmities of the actual road network in a given geographic location. Hypothetical situations can be entered into the EEVR system 114 and routes calculated based on the hypothetical situation. Areas of congestion, e.g., minimal flow and/or maximum cost can be determined and improvements of those areas can be undertaken to reduce the effect of those areas on the evacuation plan. For example, and not by way of limitation, if it is determined that a given roadway is the limiting factor between a hypothetical evacuation zone and a hypothetical safe zone, that roadway can be expanded to include additional lanes of traffic such that it no longer presents a limitation on the evacuation process for that given evacuation zone. Further, if that roadway cannot be expanded in such a fashion, studies can be undertaken to create additional roadways from the hypothetical evacuation zone to reduce the burden on any given roadway. Such planning tools are useful not only for emergency planning, but for overall traffic flow from a given area, especially areas that are prone to traffic jams such as bridges, tunnels, and other geographic areas that have limited traffic access.

Embodiments of the present invention can also be used to plan other municipal undertakings, such as the construction of new fire houses or evacuation shelters. Since embodiments of the present invention can determine the amount of time it takes to evacuate a given evacuation area via the available roads, if that time is unacceptable from a safety or other standpoint, the EEVR system 114 can determine a new safe zone that can be used for that given evacuation zone or emergency.

### CONCLUSION

A system, method and user terminal are provided to improve situational awareness by providing a real time common operating picture, including evacuation routes and emergency vehicle routes, to be available to a plurality of users.

The following describes some alternative embodiments for accomplishing the present invention. For example, any type of computer, such as a mainframe, minicomputer, or personal computer, or computer configuration, such as a timesharing mainframe, local area network, or standalone personal computer, could be used with embodiments of the present invention.

Embodiments of the present invention describe a GIS-based system that determines evacuation routes for specific areas requiring evacuation. Evacuation and safe areas are determined, and evacuation routes plotted, based on emergency-specific information as well as road flow and estimated time of travel for each section of road between the evacuation area and safe area. Routes, evacuation areas, and safe areas are dynamically calculated and recalculated based on additional data, either real-time, historical, or other data added to the system, to compute optimal initial routes and redirect evacuees if changes in the emergency situation occur.

In summary, embodiments of the invention provide methods and apparatuses for determining evacuation routes for an emergency situation using a geographical information systems (GIS) database that represents a geographical area and for providing for common situational awareness to a plurality of user terminals, wherein the GIS database includes at least one node representing at least one geographical location within the geographic area and at least one arc representing at least one street within the geographic area. A method in accordance with embodiments of the present invention comprises determining evacuation routes in response to an emergency situation, such as by determining an evacuation area within the geographic area, the evacuation area containing at least one node, determining a safe area within the geographic area, the safe area containing at least one node, dynamically determining at least one evacuation route between the evacuation area and the safe area, the evacuation route containing at least one arc, wherein the evacuation route is determined by maximizing a traffic flow between the evacuation area and the safe area, and minimizing a cost between the evacuation area and the safe area, and then providing for common situational awareness to a plurality of user terminals.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto and the equivalents thereof.

That which is claimed is:

1. A system comprising:
a plurality of user terminals configured to provide a field incident report to a computing device that provides information regarding the emergency situation based upon the field incident report, wherein the plurality of user terminals are also configured to receive and display information from the computing device including evacuation and emergency vehicle routes such that the plurality of user terminals enjoy common situational awareness.

2. A system according to claim 1 wherein at least one of the plurality of user terminals are configured to determine one or more emergency vehicle routes based upon the field incident report.

3. A system according to claim 1 wherein the plurality of user terminals are further configured to display both the one or more routes and a representation of the field incident report.

4. A system according to claim 3 wherein the representation of the of the field incident report is selected from the group consisting of a photograph, a video recording, an audio recording and a text message.

5. A system according to claim 1 wherein the plurality of user terminals are configured to receive information from the computing device identifying a plurality of emergency responders who have been dispatched in response to the emergency situation, and wherein the plurality of user terminals are also configured to display the information identifying the plurality of emergency responders and, in response to selection of a respective emergency responder, to initiate communication with the respective emergency responder.

6. A system comprising:
a computing device for receiving information associated with an emergency situation and for determining one or more routes based upon the information associated with the emergency situation, wherein the computing device provides information to the plurality of user terminals identifying a plurality of emergency responders who have been dispatched in response to the emergency situation; and
a plurality of user terminals for receiving and displaying the one or more routes from the computing device such that the plurality of user terminals enjoy common situational awareness, wherein the plurality of user terminals are configured to display the information identifying the plurality of emergency responders and, in response to selection of a respective emergency responder, to initiate communication with the respective emergency responder.

7. A system according to claim 6 wherein the information identifying the plurality of emergency responders that is provided by the computing device and displayed by the plurality of user terminals includes a presence status of the respective emergency responders.

8. A system according to claim 6 wherein the plurality of user terminals are configured to receive the selection of a plurality of emergency responders and to then initiate concurrent communications with the plurality of emergency responders.

9. A system according to claim 6 wherein the plurality of user terminals are configured to provide a field incident report to the computing device that provides additional information regarding the emergency situation, and wherein the computing device provides additional information to the plurality of user terminals based upon the field incident report.

10. A system according to claim 9 wherein the computing device provides a representation of the field incident report, and wherein the plurality of user terminals are further configured to display both the one or more evacuation and emergency vehicle routes and the representation of the field incident report.

11. A system according to claim 6 wherein the plurality of user terminals are configured to provide a field incident report that provides additional information regarding the emergency situation, wherein at least one of the plurality of user terminals is configured to determine one or more emergency vehicle routes based upon the field incident report.

12. A user terminal comprising:
a display;
a processor configured to receive one or more evacuation and emergency vehicle routes based upon an emergency situation and to direct the display to present an image of the one or more routes;
an input interface configured to receive a field incident report that provides information regarding the emergency situation; and
a transmitter configured to transmit the field incident report to a remote computing device,
wherein the processor is configured to receive information from the remote computing device based upon the field incident report.

13. A user terminal according to claim 12 wherein the processor is also configured to determine one or more emergency vehicle routes based upon the field incident report.

14. A user terminal according to claim 12 wherein the processor is configured to receive one or more updated evacuation and emergency vehicle routes based upon the field incident report and to direct the display to present an image of the one or more updated routes.

15. A user terminal according to claim 12 wherein the processor is configured to receive a representation of the field incident report and to drive the display to present an image of both the one or more evacuation and emergency vehicle routes and the representation of the field incident report.

16. A user terminal according to claim 15 wherein the representation of the field incident report is selected from the group consisting of a photograph, a video recording, an audio recording and a text message.

17. A user terminal according to claim 12 wherein the processor is further configured to receive information identifying a plurality of emergency responders who have been dispatched in response to the emergency situation and to drive the display to present an image including the information identifying the plurality of emergency responders, and wherein the processor is further configured to receive a selection of a respective emergency responder and to initiate communication via the transmitter with the respective emergency responder.

18. A method comprising:
receiving information associated with an emergency situation;
determining one or more evacuation and emergency vehicle routes based upon the information associated with the emergency situation; and
displaying the one or more routes at a user terminal such that the plurality of user terminals enjoy common situational awareness;
receiving one or more field incident reports via the user terminal that provide information regarding the emergency situation; and
updating the one or more routes displayed at the user terminal based upon the field incident report.

19. A method according to claim 18 further comprising determining one or more updated evacuation and emergency vehicle routes based upon the field incident report, and providing additional information to the user terminal based upon the field incident report.

20. A method according to claim 19 wherein providing the additional information comprises providing a representation of the field incident report for display by the user terminal along with the one or more routes.

21. A method according to claim 20 wherein the representation of the field incident report is selected from the group consisting of a photograph, a video recording, an audio recording and text message.

22. A method according to claim 18 further comprising:
providing information to the plurality of user terminals identifying a plurality of emergency responders who have been dispatched in response to the emergency situation;
displaying the information identifying the plurality of emergency responders at the plurality of user terminals;
receiving a selection of a respective emergency responder at a respective user terminal; and
initiating communication between the respective user terminal and the respective emergency responder.
